(19) United States
(12) Patent Application Publication
(10) Pub. No.: US 2010/0319247 A1
(43) Pub. Date: Dec. 23, 2010

(54) FLOWER ANCHORING DEVICE

(76) Inventors: Janice L. Anderson, Blair, OK (US); Mitchell Woodward, Martha, OK (US)

Correspondence Address: James Ray & Associates, 2640 Pitcairn Road, Monroeville, PA, 15146, US

(21) Appl. No.: 12/786,869

(22) Filed: May 25, 2010

Related U.S. Application Data
(60) Provisional application No. 61/187,772, filed on Jun. 17, 2009.

(51) Int. Cl. A01G 5/00

(52) U.S. Cl. 47/41.1

(57) ABSTRACT

A flower anchoring device for use in holding and supporting at least one predetermined floral arrangement is provided. Such device is securable to a predetermined ground surface to display such at least one predetermined floral arrangement. Such device includes a base member manufactured from a first predetermined material. Such base member includes a first substantially elongated end for insertion into a predetermined location in such predetermined ground surface for anchoring such device in such predetermined location, a second end having a predetermined shape, and a securing mechanism operably connected to such second end for releasably securing such at least one predetermined floral arrangement to such second end of such base member.

### CROSS REFERENCE TO RELATED APPLICATION

This patent application is related to and claims priority from U.S. Provisional Patent Application Ser. No. 61/187,772 filed Jun. 17, 2009.

### FIELD OF THE INVENTION

The present invention relates, in general, to a flower anchoring device that can be utilized outdoors to secure a predetermined floral arrangement in a predetermined position, such device being securable to a predetermined ground surface to display such predetermined floral arrangement.

### BACKGROUND OF THE INVENTION

Prior to the conception and development of the present invention, people have long used floral arrangements such as flowers and artificial flowers, foliage, and artificial foliage to decorate grave sites, walkways, memorial sites, gardens, lawns, parks, etc. for a variety of reasons. Unfortunately inclement and windy weather can cause such floral arrangements to deteriorate, blow away, become dislodged from their intended position, or otherwise become disarrayed.

Specifically of interest to the present invention are the following: Gall, Design Patent 511443, Gall, Design Patent 510511, Gall, Design Patent 510240, and Bjornbraten, Design Patent 419330, each disclose an ornamental design for a flower holder.

Pugh, U.S. Pat. No. 6,389,744, discloses a support for articles having an elongated portion. Mumford, U.S. Pat. No. 2,273,368, discloses a flower holder. Schouman, U.S. Pat. No. 2,229,527, Thomson, U.S. Pat. No. 2,173,217, Lapolla, U.S. Pat. No. 1,693,393, each discloses a individual plant support.

None of the referenced art provides the benefits attenuate with the present invention.

### SUMMARY OF THE INVENTION

The present invention provides a flower anchoring device for use in holding and supporting at least one predetermined floral arrangement. Such device is securable to a predetermined ground surface to display such at least one predetermined floral arrangement. Such device includes a base member manufactured from a predetermined material. Such base member includes a first substantially elongated end for insertion into a predetermined location in such predetermined ground surface for anchoring such device in such predetermined location. Such base member further includes a second end having a predetermined shape. A securing means is operably connected to such second end for releasably securing such at least one predetermined floral arrangement to such second end of such base member.

### OBJECTS OF THE INVENTION

It is, therefore, one of the primary objects of the present invention to provide a device for engaging with a predetermined ground surface such as within a yard, cemetery, park, memorial site, lawn, garden, etc. for holding and supporting a predetermined floral arrangement such as artificial flowers, live flowers, artificial foliage, live foliage, and a combination thereof and securing such predetermined floral arrangement such that weather will not dislodge such predetermined floral arrangement from its position.

Another object of the present invention is to provide a decorative flower anchoring device which can be anchored in the ground in a predetermined location and which may be used to hold and support a predetermined arrangement of at least one of artificial flowers, live flowers, artificial foliage, live foliage, and a combination.

Still another object of the present invention is to provide an outdoor flower holder for use in supporting a predetermined floral arrangement such that such floral arrangement in a predetermined position for an extended period of time.

Yet another object of the present invention is to provide a device for supporting a floral arrangement on a grave within a cemetery such that such floral arrangement will not be blown away or become otherwise disheveled by wind and other inclement weather thereby comforting the family of the deceased.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention; such device is depicted anchored into the ground and holding a predetermined floral arrangement by means of three ring members each positioned on the base member to receive a stem portion of such predetermined floral arrangement.

FIG. 2 is a partial perspective view of the invention according to one embodiment of the invention in which such first end of such base member is threaded and pointed.

FIG. 3a is a partial perspective view of the invention according to one embodiment of the invention; such base member includes a plurality of ring members disposed thereon for securing multiple floral arrangements.

FIG. 3b is a partial perspective view of the invention according to one embodiment of the invention in which such predetermined decorative shaped member is a cross.

FIG. 3c is a partial perspective view of the invention according to one embodiment of the invention in which such predetermined decorative shaped member is a horse-shoe.

FIG. 4 is a partial perspective view of the invention according to one embodiment of the invention; such second end of such base member is formed as a boot.

FIG. 5 is a partial perspective view of the invention according to one embodiment of the invention; such second end of such base member includes six ring members attached thereto for securing two predetermined floral arrangements side by side.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

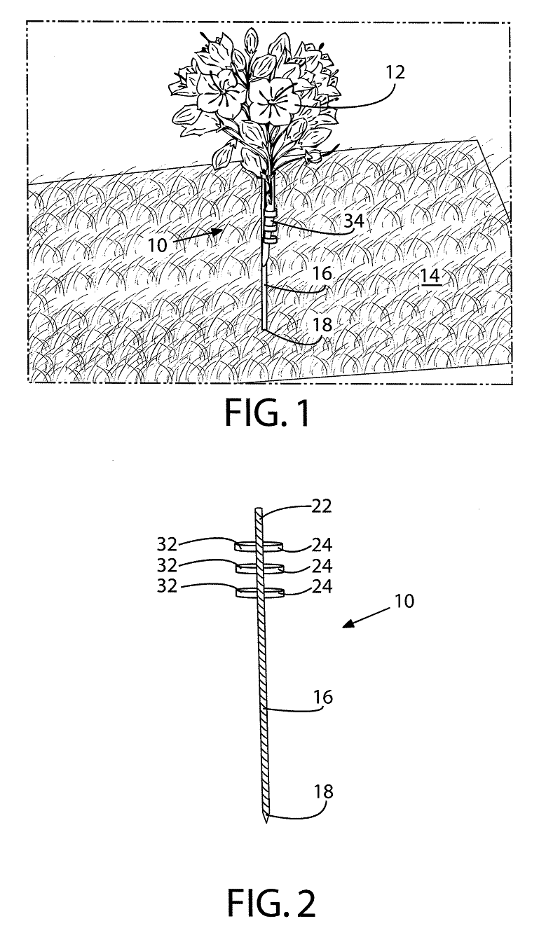

Reference is now made, more particularly, to FIGS. 1-5. A flower anchoring device is generally designated 10. Such flower anchoring device is for use in holding and supporting at least one predetermined floral arrangement 12. Such device is formed for being secured to a predetermined location of a predetermined ground surface 14 to display such predetermined floral arrangement 12. Such at least one predetermined floral arrangement may include real flowers, artificial flowers, real foliage, artificial foliage, and a combination thereof. Such at least one predetermined floral arrangement is not meant to be limited and may include all contemplatable variations of flowers, greenery, foliage, plants, brush, and the like, whether live or artificial.

Such flower anchoring device 10 includes a base member 16 having a first substantially elongated end 18, preferably formed as a stake, for insertion into such ground surface 14 thereby anchoring such device 10 in such predetermined location.

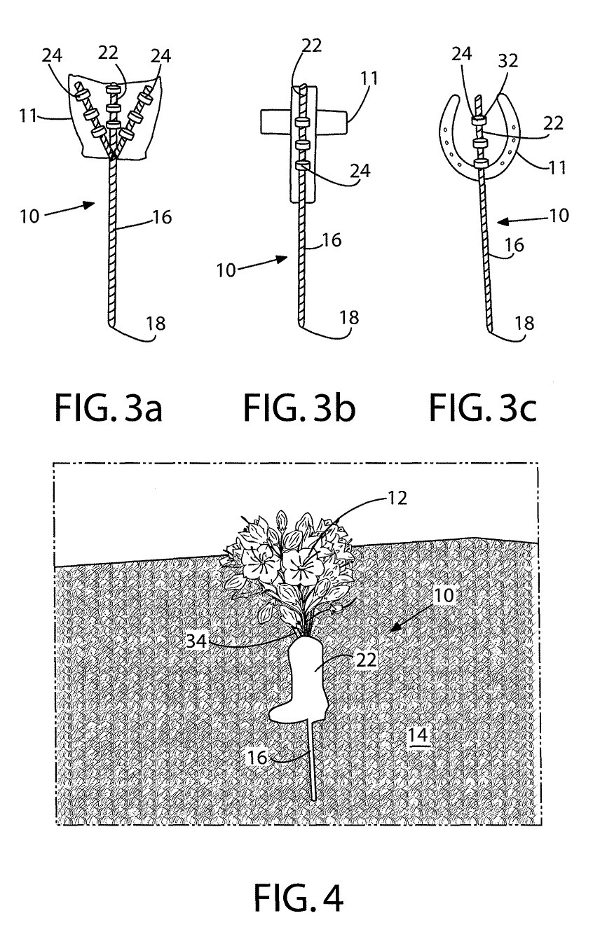

A second end 22 of such base member 16 has a predetermined shape. Such second end 22 is at least one of formed as a predetermined decorative shape, attached to a predetermined decorative shaped member, and a combination thereof. Such predetermined decorative shape is preferably at least one of a cross, a heart, a cowboy boot, a predetermined animal, a predetermined object, a predetermined person, a plurality of predetermined objects, a plurality of predetermined persons, and a combination thereof. However, such predetermined decorative shape may be any shape desired by a user and is not meant to be limited. Such predetermined decorative shaped member is preferably at least one of a cross, a heart, a cowboy boot, a predetermined animal, a predetermined object, a predetermined person, a plurality of predetermined objects, a plurality of predetermined persons, and a combination thereof. However, such predetermined decorative shaped member may be any shape desired by the user and is not meant to be limited. As illustrated in FIG. 3a, FIG. 3b, and FIG. 3c, such second end 22 is attached to a predetermined decorative shaped member 11. As illustrated in FIG. 4, such second end 22 is formed as a predetermined decorative shape; a boot.

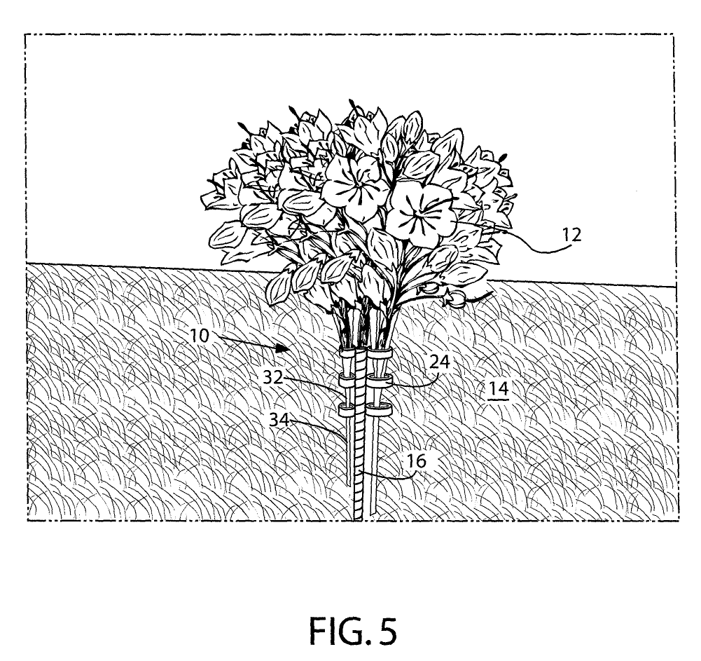

A securing means 24 is operably connected to such second end 22 of such flower anchoring device 10. Such securing means 24 is preferably at least one ring member 32 operably connected to such second end 22 of such base member 16 at a predetermined location thereon, such at least one ring member 32 being for receiving a stem portion 34 of such at least one predetermined floral arrangement 12. It is presently preferred that such device 10 includes at least three ring members as illustrated in FIG. 1 and FIGS. 3a, 3b, and 3c. It is presently preferred that such three rings are aligned that such a stem portion of such predetermined floral arrangement will pass through each ring. As illustrated in FIG. 2, FIG. 3a, and FIG. 5, however, a plurality of ring members may be attached to such base member in positions enabling a user to secure a plurality of predetermined floral arrangements thereto, for example side by side, etc.

Such base member 16 is preferably manufactured from a predetermined material such as metal, plastic, wood, and a combination thereof. Such base member 16 is preferably between about 10 and 20 inches in height.

Preferably such stake is at least one of pointed, threaded, and a combination thereof as illustrated specifically in FIG. 2. It is meant that a user (not shown) insert such first end 18 of such base member 16 into the ground surface 14 and thereafter insert a stem portion of such at least one predetermined floral arrangement 12 into such at least one ring member 32. Such first end of such base member may be pushed into the ground, hammered into the ground, screwed into the ground, and a combination thereof as is required due to ground temperature, composition, wetness, etc., and such at least one predetermined floral arrangement secured by the device in any manner pleasing to the user. The device may be used over and over again.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A flower anchoring device for use in holding and supporting at least one predetermined floral arrangement, said device being securable to a predetermined ground surface to display such at least one predetermined floral arrangement, said device comprising:
a. a base member manufactured from a predetermined material, said base member including;
i. a first substantially elongated end for insertion into a predetermined location of such predetermined ground surface for anchoring said device in such predetermined location;
ii. a second end having a predetermined shape; and
b. a securing means operably connected to said second end for releasably securing said at least one predetermined floral arrangement to said second end of said base member.

2. A flower anchoring device according to claim 1 wherein said first end of said base member is formed substantially as a stake.

3. A flower anchoring device according to claim 2 wherein said stake is at least one of pointed, threaded, and a combination thereof.

4. A flower anchoring device according to claim 1 wherein said base member is between about 8 inches and about 20 inches long.

5. A flower anchoring device according to claim 1 wherein said second end is at least one of formed as a predetermined decorative shape, attached to a predetermined decorative shaped member, and a combination thereof.

6. A flower anchoring device according to claim 5 wherein said predetermined decorative shape is at least one of a cross, a heart, a cowboy boot, a predetermined animal, a predetermined object, a predetermined person, a plurality of predetermined objects, a plurality of predetermined persons, and a combination thereof.

7. A flower anchoring device according to claim 5 wherein said predetermined decorative shaped member is at least one of a cross, a heart, a cowboy boot, a predetermined animal, a predetermined object, a predetermined person, a plurality of predetermined objects, a plurality of predetermined persons, and a combination thereof.

8. A flower anchoring device according to claim 1 wherein said securing means is at least one ring member operably connected to said second end of such base member, said at least one ring member being for receiving a stem portion of such at least one predetermined floral arrangement.

9. A flower anchoring device according to claim 8 wherein said securing means includes at least three ring members.

10. A flower anchoring device according to claim 1 wherein said predetermined material is at least one of metal, plastic, wood, and a combination thereof.

11. A flower anchoring device according to claim 10 wherein said predetermined material is metal.
